(19) United States
(12) Patent Application Publication
(10) Pub. No.: US 2015/0248508 A1
(43) Pub. Date: Sep. 3, 2015

(54) INFORMATION SYSTEM CONSTRUCTION DEVICE, INFORMATION SYSTEM CONSTRUCTION METHOD, AND STORAGE MEDIUM

(71) Applicant: NEC CORPORATION, Minato-ku, Tokyo (JP)

(72) Inventor: Hiroshi Sakaki, Tokyo (JP)

(21) Appl. No.: 14/430,616

(22) PCT Filed: Sep. 17, 2013
(86) PCT No.: PCT/JP2013/005467

§ 371 Date: Mar. 24, 2015

(30) Foreign Application Priority Data
Oct. 2, 2012 (JP) 2012-220526

(51) Int. Cl. G06F 17/50

(52) U.S. Cl. CPC G06F 17/5009

(57) ABSTRACT

An information system construction device includes a system model selection unit that selects a system model that satisfies a construction requirement among system models when the construction requirement of a system is input, an operation information acquisition unit that acquires operation information of an existing system based on the selected system model and a similar system model, a parameter computation unit that computes an evaluation parameter by using a parameter included in the operation information, a performance evaluation unit that evaluates the performance of the selected system model on the basis of the evaluation parameter, a sizing factor change unit that changes a sizing factor of the selected system model by comparing the evaluated performance of the system model with the input construction requirement, and a system construction unit that constructs the information system by using the system model after sizing factor change.

### TECHNICAL FIELD

The present invention relates to an information system construction device, an information system construction method, and a storage medium.

### BACKGROUND ART

With advance of cloud computing technology, it has been possible that a user using a cloud environment constructs and manages relatively easily an information system having a size necessary for an operation by aggregating servers, storages, and the like necessary to operate the information system on a virtual data center. PTL 1 mentioned below discloses a technology that changes the configuration of an information system in response to a predicted situation of a load at a virtualized data center under a cloud environment.

In the technology described in PTL 1, the operation information (a throughput such as the CPU (Central Processing Unit) utilization rate) at the time of actual operation in a production environment or a test environment is stored in a DB (Data Base) beforehand in association with the configuration (snap shot) of an information system that is the source of the operation information. A system operator retrieves and selects a system configuration capable of associating with an anticipated load (throughput) from the DB, and changes the configuration of the information system by applying the selected system configuration.

Further, an information system management device that automatically improves an operation policy is described in PTL 2.

### CITATION LIST

### Patent Literature

PTL 1: Japanese Laid-open Patent Publication No. 2011-113267

PTL 2: PCT International Publication No. 2006/095506

### SUMMARY OF INVENTION

### Technical Problem

Generally, though the system configuration remains the same, when a sizing factor such as the number of servers that configure a system, the number of cores of each CPU, or the like, is changed, the content of the operation information changes at the time of operating the system. Therefore, in order to change an information system configuration to an optimal one, there is a need to include the performance at the time of the change of sizing factor in a target of evaluation.

However, a system configuration not registered in the DB may not be selected as a target of change by the technology described in PTL 1. Therefore, when the performance after the sizing factor is changed is also included in a target of evaluation, system configurations that associate with all the combinations of sizing factors need to be operated beforehand, and results of the operations need to be registered in the DB. However, the combination of sizing factors reaches such a huge number that it is not practical to register all the results.

The present invention has been accomplished in order to solve the foregoing problems, and it is one of the objects of the present invention to provide an information system construction device, an information system construction method, and an information system construction program that enable to construct an optimal information system which suits construction requirements after flexibly evaluating the performances of a variety of system configurations.

### Solution to Problem

An information system construction device of an exemplary aspect of the present invention includes: a system model selection unit that selects a system model that satisfies a construction requirement among system models set in a unit of previously stored design information of a system when the construction requirement of a construction planned system that is an information system to be constructed is input; an operation information acquisition unit that acquires operation information of an existing system that is an already constructed information system based on the system model selected by the system model selection unit and a similar system model that is similar to the system model selected; a parameter computation unit that computes an evaluation parameter that is used when performance of the system model is evaluated, by using a parameter included in the operation information acquired by the operation information acquisition unit; a performance evaluation unit that evaluates the performance of the system model selected by the system model selection unit, on the basis of the evaluation parameter computed by the parameter computation unit; a server element change unit that changes a server element that is an element that determines a size regarding a server included in design information of the system model selected by the system model selection unit, by comparing the evaluated performance of the system model by the performance evaluation unit with the input construction requirement; and a system construction unit that constructs the construction planned system by using the system model having the server element changed by the server element change unit.

An information system construction method of an exemplary aspect of the present invention includes: selecting a system model that satisfies a construction requirement among system models set in a unit of previously stored design information of a system when the construction requirement of a construction planned system that is an information system to be constructed is input; acquiring operation information of an existing system that is an already constructed information system based on the selected system model and a similar system model that is similar to the selected system model; computing an evaluation parameter that is used when performance of the system model is evaluated, by using a parameter included in the acquired operation information; evaluating the performance of the selected system model, on the basis of the computed evaluation parameter; changing a server element that is an element that determines a size regarding a server included in design information of the selected system model, by comparing the evaluated performance of the system model with the input construction requirement; and constructing the construction planned system by using the system model having the changed server element.

A computer-readable storage medium of an exemplary aspect of the present invention records an information system construction program for causing a computer to execute: a system model selection process of selecting a system model that satisfies a construction requirement among system models set in a unit of previously stored design information of a system when the construction requirement of a construction planned system that is an information system to be constructed is input; an operation information acquisition process of acquiring operation information of an existing system that is an already constructed information system based on the system model selected in the system model selection process and a similar system model that is similar to the system model selected; a parameter computation process of computing an evaluation parameter that is used when performance of the system model is evaluated, by using a parameter included in the operation information acquired in the operation information acquisition process; a performance evaluation process of evaluating the performance of the system model selected in the system model selection process, on the basis of the evaluation parameter computed in the parameter computation process; a server element change process of changing a server element that is an element that determines a size regarding a server included in design information of the system model selected in the system model selection process, by comparing the evaluated performance of the system model in the performance evaluation process with the input construction requirement; and a system construction process of constructing the construction planned system by using the system model having the server element changed in the server element change process.

### Advantageous Effects of Invention

According to the present invention, it is possible to construct an optimal information system that suits construction requirements after flexibly evaluating the performances of a variety of system configurations.

### BRIEF DESCRIPTION OF DRAWINGS

FIG. 1 is a diagram illustrating an example of a configuration of an information system construction device in an exemplary embodiment.

FIG. 2 is an example of a screen used when a user constructs an information system.

FIG. 3 is an example of a screen configuration displayed in a service level requirement selection area illustrated in FIG. 2.

FIG. 4 is an example of a screen configuration displayed in a functional requirement selection area illustrated in FIG. 2.

FIG. 5 is an example of a screen configuration displayed in a system model candidate display area illustrated in FIG. 2.

FIG. 6 is an example of a screen displaying evaluation parameters.

FIG. 7 is a flowchart for illustrating a procedure for constructing an information system.

### DESCRIPTION OF EMBODIMENTS

Hereinafter, referring to the accompanying drawings, a suitable exemplary embodiment of an information system construction device, an information system construction method, and an information system construction program storage medium according to the present invention will be described. The information system construction device according to the exemplary embodiment is a device that evaluates the performances of various information systems constructed by utilizing a virtual machine under a cloud environment and construction of an information system matched with construction requirements presented by a user is supported.

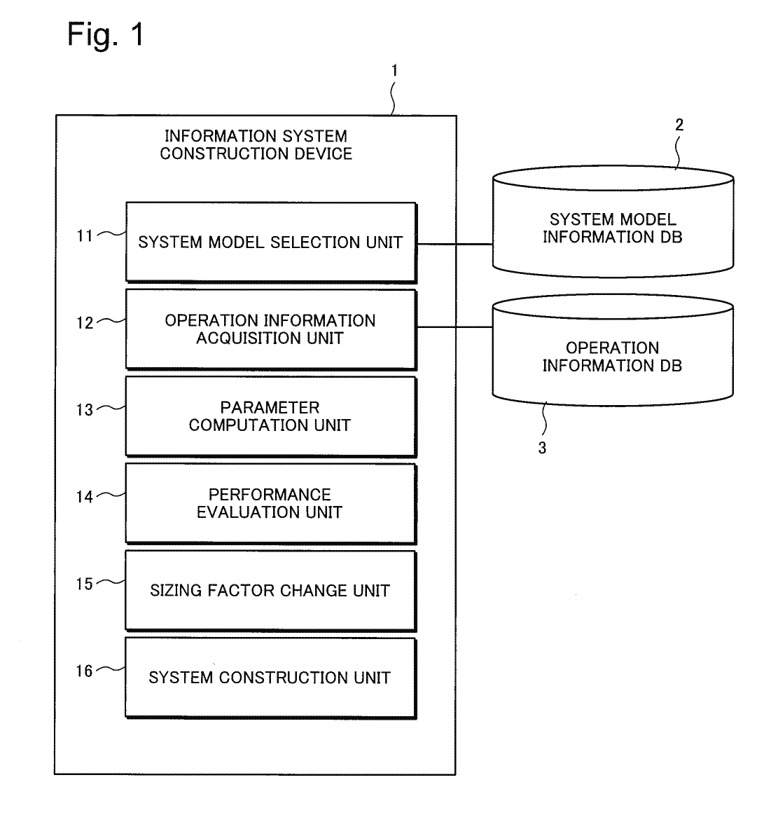

First, referring to FIG. 1, a configuration of the information system construction device according to the exemplary embodiment is described. As illustrated in FIG. 1, an information system construction device 1 functionally includes, for example, a system model selection unit 11, an operation information acquisition unit 12, a parameter computation unit 13, a performance evaluation unit 14, a sizing factor (server element) change unit 15, and a system construction unit 16.

Here, the information system construction device 1 physically includes, for example, a CPU, a storage device, and an input/output interface. The storage device includes, for example, a ROM (Read Only Memory) and an HDD (Hard Disk Drive) storing a program and data processed by the CPU, a RAM (Random Access Memory) used as various work areas mainly for control processing, and the like. These elements are connected to each other via a bus. The CPU executes the program stored on the ROM and processes a message received via the input/output interface, data developed on the RAM, and the like, to realize functions of the respective units in the information system construction device 1.

When a user inputs a construction requirement of an information system planned to be constructed from now by the user (hereinafter, referred to as a “construction planned system”), the system model selection unit 11 selects a system model that satisfies the construction requirement referring to a system model information DB 2. The system model selection unit 11 selects a plurality of system models, when a plurality of system models exist that satisfy the construction requirement.

As the construction requirement, for example, a functional requirement and a service level requirement are usable. The functional requirement is a condition for determining a role played by an application and includes, for example, functions such as data processing, a data store, an image analysis, response creation, statistical processing, and inventory management. The service level requirement is condition for determining a guarantee level of quality provided by the construction planned system, and include, for example, guarantee levels of a response time, a request throughput, a maximum CPU load, an error rate, a safety factor, and the like.

The system model is a model set in a design information unit for constructing an information system. The design information includes pieces of information describing, for example, a configuration of a network, a configuration of a server, a relation among components of an application, a processing flow indicating an operation of the application, and the like.

The system model information DB 2 is a database that stores system model information including design information of an already constructed information system (hereinafter, referred to as an “existing system”). The system model information DB 2 is designed so as to be able to search system model information using a construction requirement as a key. The system model information DB 2 may be included within the information system construction device 1 or may be provided outside.

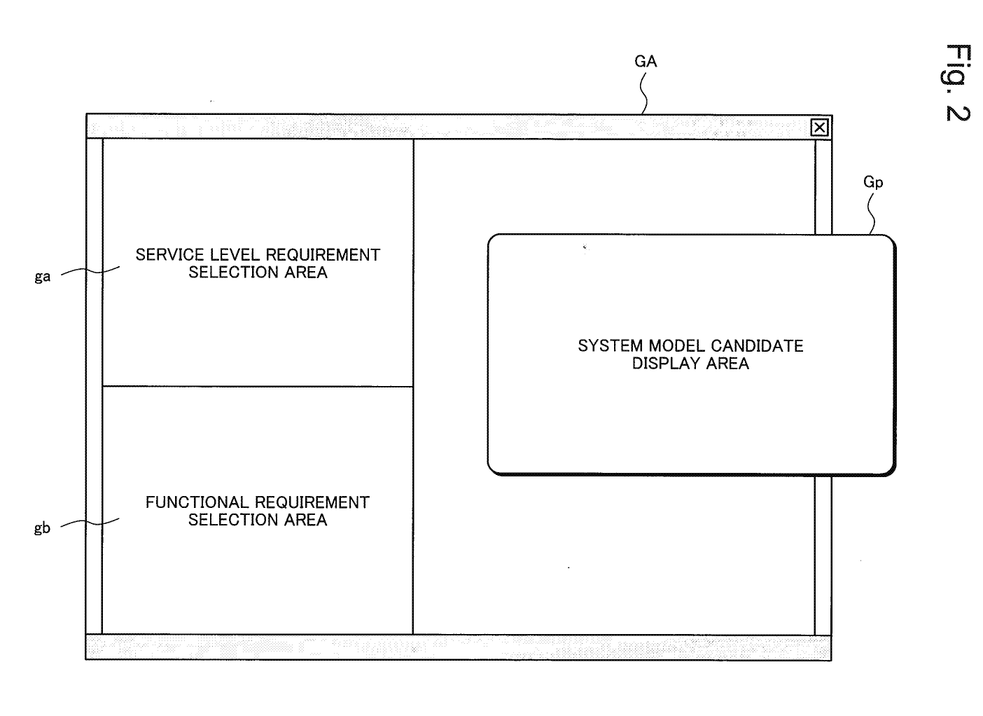

A user accesses the information system construction device 1 by operating a user terminal (not illustrated) and constructs an information system using various types of screens provided by the information system construction device 1. With reference to FIG. 2, a screen used by a user is described. FIG. 2 is an example of a screen used when a user constructs an information system. On a display screen GA, an area ga for selecting a service level requirement and an area gb for selecting a functional requirement are disposed. When a system model satisfying a construction requirement is selected, an area Gp that displays one or a plurality of selected system models as candidates is popup-displayed on the display screen GA.

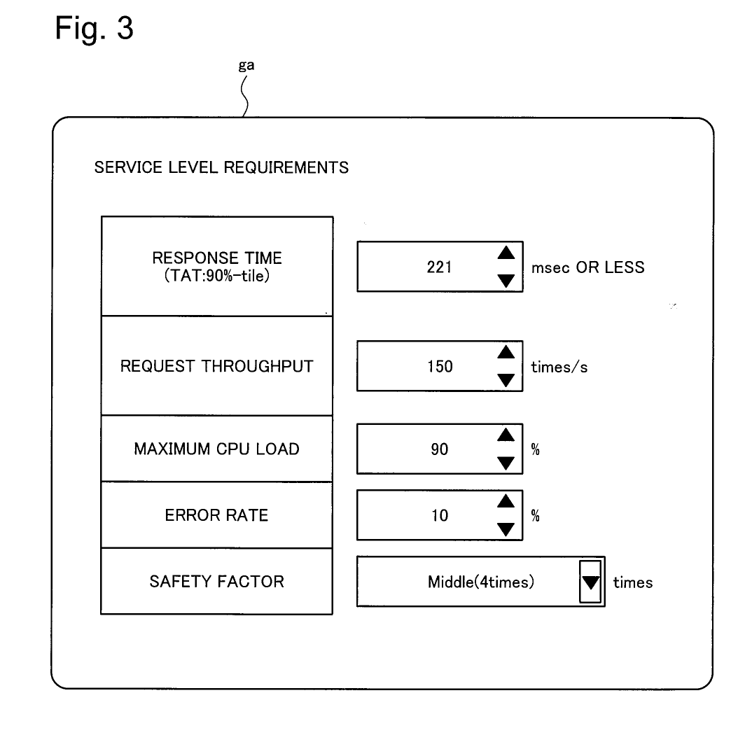

An example of a screen configuration displayed in the service level requirement selection area ga is illustrated in FIG. 3. As illustrated in FIG. 3, in the service level requirement selection area ga, various items for performing a selective input of respective guarantee levels of a response time, a request throughput, a maximum CPU load, an error rate, and a safety factor are displayed as service level requirements. The user performs a selective input of service level requirements that the user desires for the construction planned system by utilizing the service level requirement selection area ga.

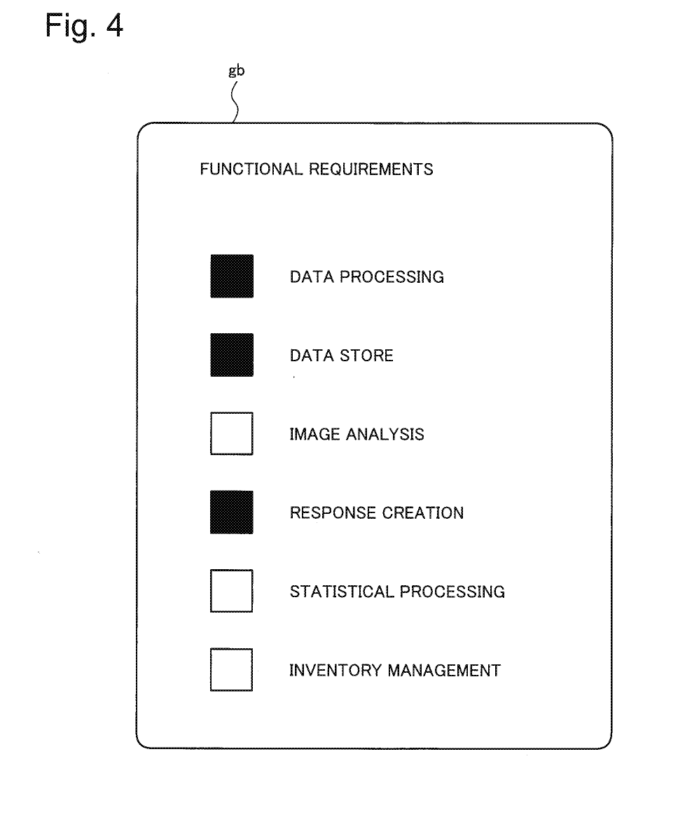

An example of a screen configuration displayed in the functional requirement selection area gb is illustrated in FIG. 4. As illustrated in FIG. 4, in the functional requirement selection area gb, various types of items for selectively inputting data processing, data store, image analysis, response creation, statistical processing, and inventory management as functional requirements are displayed. A user performs a selective input of a desired functional requirement for a construction planned system through the functional requirement selection area gb.

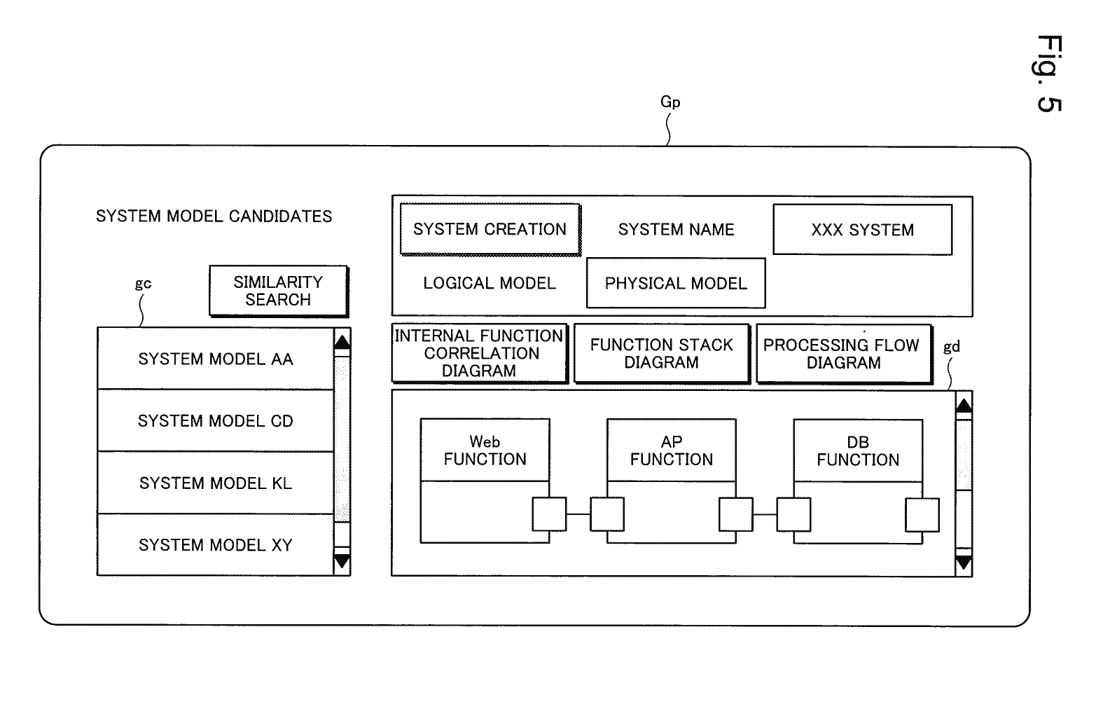

An example of a screen configuration displayed in the system model candidate display area Gp is illustrated in FIG. 5. As illustrated in FIG. 5, the system model candidate display area Gp includes an area gc for selecting a system model to be employed for performance evaluation and an area gd for displaying a model diagram of the system model selected in the selection area gc.

In the selection area gc, one or more system models selected by the system model selection unit 11 are displayed. The model diagram displayed in the display area gd includes, for example, an internal function correlation diagram, a function stack diagram, a processing flow diagram, and the like. A user causes performance evaluation of a construction planned system and construction of an information system to be executed, through the system model candidate display area Gp. Specifically, a user selects, for example, one system model in the selection area gc and causes performance evaluation of a construction planned system to be executed by clicking a similarity search button. A user accepting the evaluation result causes construction of an information system to be executed by clicking a system creation button.

The operation information acquisition unit 12 illustrated in FIG. 1 acquires operation information of an existing system constructed in the past by employing a system model selected by the system model selection unit 11, from an operation information DB 3. When a plurality of system models selected by the system model selection unit 11 exist, the operation information acquisition unit 12 acquires operation information of an existing system employing a system model selected by a user in the selection area gc, from the operation information DB 3.

The operation information acquisition unit 12 further acquires operation information of an existing system constructed in the past by employing a system model similar to the system model selected by the system model selection unit 11, from the operation information DB 3. In the present exemplary embodiment, for convenience of description, a set of the system model selected by the system model selection unit 11 and a system model similar to the system model is referred to as a “selected system model group”.

As the system model similar to the selected system model, for example, a system model having design information different from design information of the selected system model only in a sizing factor of a server, is employable.

The sizing factor of a server is a element (server element) for determining a size of the server and includes, for example, the number of servers, the number of cores of a CPU mounted in the server, and the like.

The operation information is information managed by an operator operating an information system and includes, for example, a load of a CPU, a processing number of requests, a failure history of a hard disk, and the like.

The operation information DB 3 is a database that stores operation information of an existing system. The operation information DB 3 is designed so as to be able to search operation information using a system model as a key. The operation information DB 3 may be included within the information system construction device 1 or may be provided outside.

The parameter computation unit 13 computes evaluation parameters used upon evaluating non-functional requirements such as performance and reliability of an information system, expandability, security, and mission critical property (hereinafter, referred to as “MC (Mission Critical) property”), by using parameters included in operation information acquired by the operation information acquisition unit 12. Indicators of the non-functional requirements increase as quality indicators, such as reliability, availability, and maintainability, and performance indicators such as performance increase.

As the parameters, for example, an arrival rate of requests, an average transmission size of application messages, a Web load represented by an average CPU time, a Web read load represented by a disk read time, a Web write load represented by a disk write time, an average size on SQL execution, an application load represented by an average CPU time, an application write load represented by a disk write time, and the like are usable.

The evaluation parameter is provided in accordance with each parameter included in operation information of a selected system model group acquired by the operation information acquisition unit 12. As a value of the evaluation parameter, an average value of parameter values of the selected system model group is set.

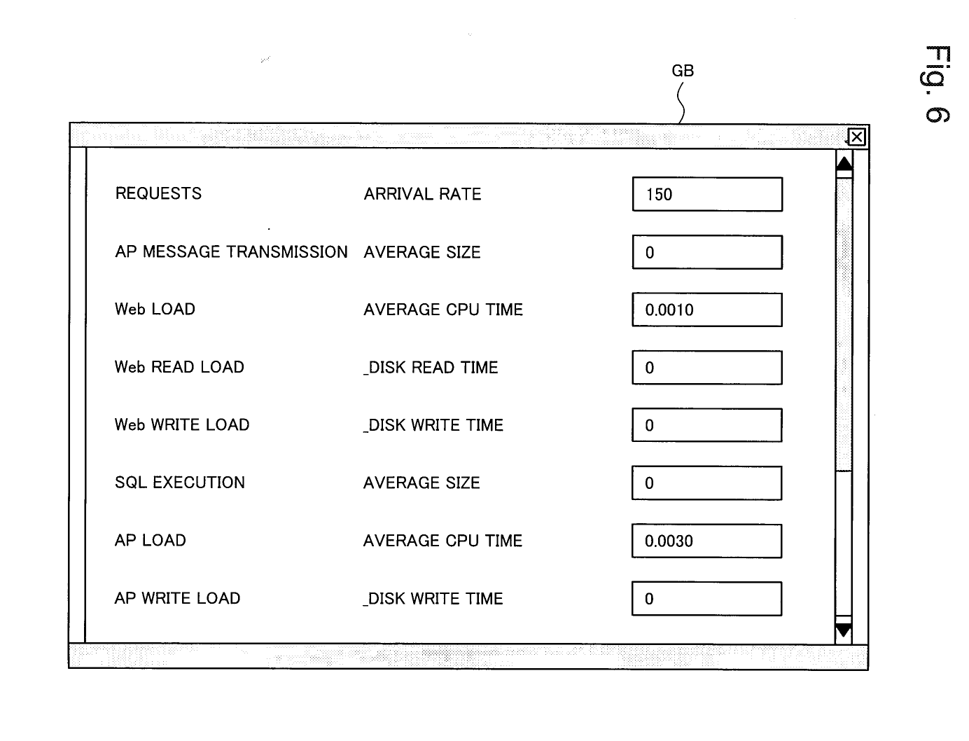

FIG. 6 illustrates an example of a display screen of evaluation parameters. As illustrated in FIG. 6, in an evaluation parameter display screen GB, item names of evaluation parameters and values of the evaluation parameters are displayed in a list format.

The performance evaluation unit 14 illustrated in FIG. 1 evaluates performance of a system model selected by the system model selection unit 11, on the basis of evaluation parameters computed by the parameter computation unit 13.

The sizing factor change unit 15 changes the sizing factor of the system model selected by the system model selection unit 11 by comparing the results of evaluation by the performance evaluation unit 14 with the service levels performed a selective input by a user. In other words, the sizing factor change unit 15 changes the sizing factor of the system model selected by the system model selection unit 11 so that the selected system model satisfies the service levels performed a selective input by the user.

The system construction unit 16 constructs the construction planned system by using the system model after a sizing factor is changed by the sizing factor change unit 15. The construction planned system is constructed by allocating a virtual machine provided on a virtualized data center.

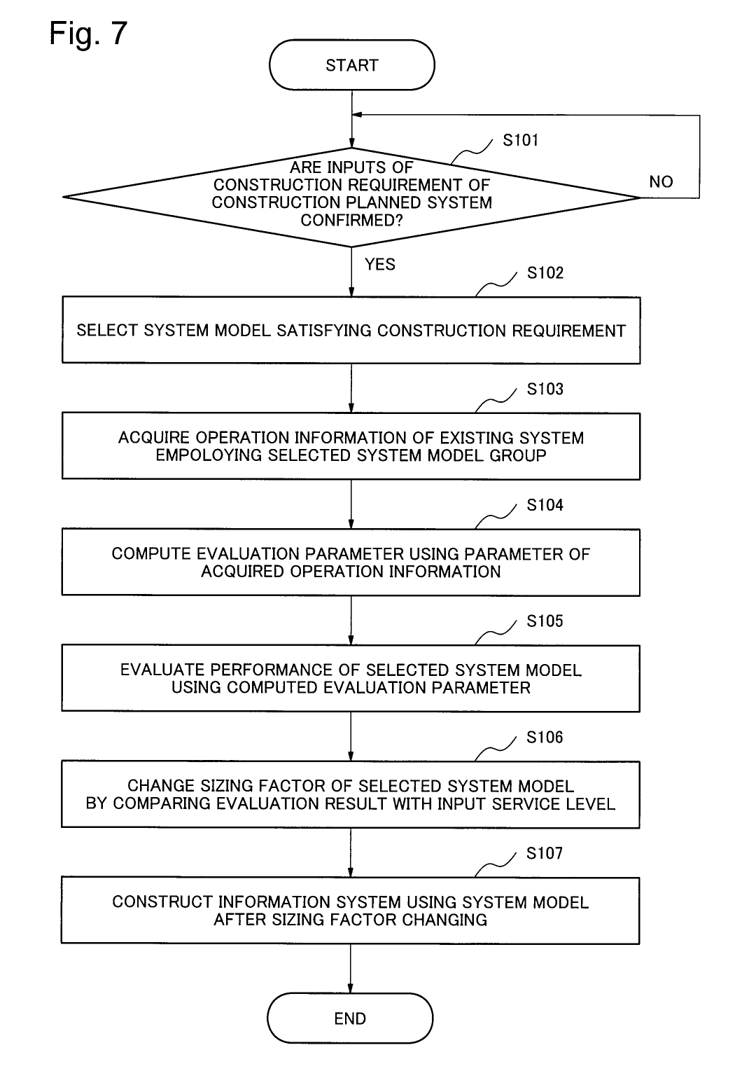

Next, referring to FIG. 7, operation of the information system construction device 1 will be described. FIG. 7 is a flowchart for illustrating a procedure for constructing an information system.

First, the system model selection unit 11 determines whether or not input of functional requirements and service level requirements that are construction requirements of the construction planned system are confirmed by a user (step S101). When the determination is NO (step S101; NO), the system model selection unit 11 waits until the determination turns into YES.

On the other hand, in the determination of step S101, when the input of the functional requirements and the service level requirements are determined to be confirmed (step S101; YES), the system model selection unit 11 selects a system model that satisfies the functional requirements and the service level requirements referring to the system model information DB 2 (step S102). When a plurality of selected system models exist, the number of system models to be selected in step S102 is narrowed down to one by causing the user to select any one of the system models.

The operation information acquisition unit 12 acquires operation information of an existing system employing the system model selected in the aforementioned step S102 and a system model similar to the selected system model respectively from the operation information DB 3 (step S103).

The parameter computation unit 13 computes evaluation parameters used upon evaluating non-functional requirements of the information system, by using parameters included in the operation information acquired in the aforementioned step S103 (step S104).

The performance evaluation unit 14 evaluates the performance of the system model selected in the aforementioned step S102, on the basis of the evaluation parameters computed in the aforementioned step S104 (step S105).

The sizing factor change unit 15 changes the sizing factor of the system model selected in the aforementioned step S102 by comparing the results of the evaluation performed in the aforementioned step S105 with the service levels input in the aforementioned step S101 (step S106).

The system construction unit 16 constructs an information system by using the system model after a sizing factor is changed in the aforementioned step S106 (step S107).

As described above, according to the information system construction device 1 in the exemplary embodiment, the system model selection unit 11 selects a system model satisfying functional requirements and service level requirements input by a user. Then, the operation information acquisition unit 12 acquires operation information of an existing system associated with a selected system model group. Further, the parameter computation unit 13 computes evaluation parameters by using parameters included in the acquired operation information. Furthermore, the performance evaluation unit 14 evaluates performance of the selected system model based on the evaluation parameters. Then, the sizing factor change unit 15 compares the evaluated performance of the system model with the input service level requirements and changes the sizing factor of the server included in the design information of the selected system model. Therefore, the system construction unit 16 can construct the information system by using the system model after a sizing factor is changed.

Hereby, the system model that satisfies the construction requirements input by the user can be selected as a candidate for the construction planned system. Then, by using the evaluation parameters computed, based on the operation information of the existing system associated with the selected system model group, it is possible to evaluate the non-functional requirements of the selected system model, and to customize the sizing factor of the selected system model so as to satisfy the service level requirements input by the user, by comparing the results of the evaluation with the service level requirements input by the user. Further, by using the post-customization system models, an information system can be constructed.

Therefore, according to the information system construction device 1 in the exemplary embodiment, it becomes possible to construct an optimal information system that suits the construction requirements after flexibly evaluating the performances of a variety of system configurations.

The exemplary embodiment described above is only illustrative and does not exclude various modifications and applications of the technique which are not expressed in the exemplary embodiment. In other words, the present invention can be carried out by being modified to various embodiments without departing from the gist of the present invention.

A part or whole of the exemplary embodiment described above can be described as the following supplementary notes but the present invention is not limited to the following.

(Supplementary Note 1) An information system construction device including: a system model selection unit that selects a system model that satisfies a construction requirement among system models set in a unit of previously stored design information of a system when the construction requirement of a construction planned system that is an information system to be constructed is input; an operation information acquisition unit that acquires operation information of an existing system that is an already constructed information system based on the system model selected by the system model selection unit and a similar system model that is similar to the system model selected; a parameter computation unit that computes an evaluation parameter that is used when performance of the system model is evaluated, by using a parameter included in the operation information acquired by the operation information acquisition unit; a performance evaluation unit that evaluates the performance of the system model selected by the system model selection unit, on the basis of the evaluation parameter computed by the parameter computation unit; a server element change unit that changes a server element that is an element that determines a size regarding a server included in design information of the system model selected by the system model selection unit, by comparing the evaluated performance of the system model by the performance evaluation unit with the input construction requirement; and a system construction unit that constructs the construction planned system by using the system model having the server element changed by the server element change unit.

(Supplementary Note 2) The information system construction device according to Supplementary Note 1, wherein the construction requirement is a functional requirement for determining a role played by an application and a service level requirement for determining a guarantee level of quality provided by the construction planned system, and the server element change unit compares the evaluated performance of the system model by the performance evaluation unit with the input service level requirement.

(Supplementary Note 3) The information system construction device according to Supplementary Note 1 or 2, wherein the similar system model is the system model with another piece of the design information different from the design information of the system model selected by the system model selection unit in only the server element.

(Supplementary Note 4) The information system construction device according to any one of Supplementary Notes 1 to 3, wherein the performance of the system model is a non-functional requirement.

(Supplementary Note 5) An information system construction method including: a system model selection step of selecting a system model that satisfies a construction requirement among system models set in a unit of previously stored design information of a system when the construction requirement of a construction planned system that is an information system to be constructed is input; a operation information acquisition step of acquiring operation information of an existing system that is an already constructed information system based on the system model selected in the system model selection step and a similar system model that is similar to the system model selected; a parameter computation step of computing an evaluation parameter that is used when performance of the system model is evaluated, by using a parameter included in the operation information acquired in the operation information acquisition step; a performance evaluation step of evaluating the performance of the system model selected in the system model selection step, on the basis of the evaluation parameter computed in the parameter computation step; a server element change step of changing a server element that is an element that determines a size regarding a server included in design information of the system model selected in the system model selection step, by comparing the evaluated performance of the system model in the performance evaluation step with the input construction requirement; and a system construction step of constructing the construction planned system by using the system model having the server element changed in the server element change step.

(Supplementary Note 6) The information system construction method according to Supplementary Note 5, wherein the construction requirement is a functional requirement for determining a role played by an application and a service level requirement for determining a guarantee level of quality provided by the construction planned system, and the server element change step compares the evaluated performance of the system model in the performance evaluation step with the input service level requirement.

(Supplementary Note 7) The information system construction device according to Supplementary Note 5 or 6, wherein the similar system model is the system model with another piece of the design information different from the design information of the system model selected in the system model selection step in only the server element.

(Supplementary Note 8) The information system construction method according to any one of Supplementary Notes 5 to 7, wherein the performance of the system model is a non-functional requirement.

(Supplementary Note 9) A computer-readable storage medium recording an information system construction program that causes a computer to execute: a system model selection process of selecting a system model that satisfies a construction requirement among system models set in a unit of previously stored design information of a system when the construction requirement of a construction planned system that is an information system to be constructed is input; an operation information acquisition process of acquiring operation information of an existing system that is an already constructed information system based on the system model selected in the system model selection process and a similar system model that is similar to the system model selected; a parameter computation process of computing an evaluation parameter that is used when performance of the system model is evaluated, by using a parameter included in the operation information acquired in the operation information acquisition process; a performance evaluation process of evaluating the performance of the system model selected in the system model selection process, on the basis of the evaluation parameter computed in the parameter computation process; a server element change process of changing a server element that is an element that determines a size regarding a server included in design information of the system model selected in the system model selection process, by comparing the evaluated performance of the system model in the performance evaluation process with the input construction requirement; and a system construction process of constructing the construction planned system by using the system model having the server element changed in the server element change process.

(Supplementary Note 10) The computer-readable storage medium according to Supplementary Note 9, wherein the construction requirement is a functional requirement for determining a role played by an application and a service level requirement for determining a guarantee level of quality provided by the construction planned system, and the server element change process compares the evaluated performance of the system model in the performance evaluation process with the input service level requirement.

(Supplementary Note 11) The computer-readable storage medium according to Supplementary Note 9 or 10, wherein the similar system model is the system model with another piece of the design information different from the design information of the system model selected in the system model selection process in only the server element.

(Supplementary Note 12) The computer-readable storage medium according to any one of Supplementary Notes 9 to 11, wherein the performance of the system model is a non-functional requirement.

This application is based upon and claims the benefit of priority from Japanese patent application No. 2012-220526, filed on Oct. 2, 2012, the disclosure of which is incorporated herein in its entirety by reference.

### REFERENCE SIGNS LIST

1 Information system construction device
2 System model information DB
3 Operation information DB
11 System model selection unit
12 Operation information acquisition unit
13 Parameter computation unit
14 Performance evaluation unit
15 Sizing factor change unit
16 System construction unit

What is claimed is:

1. An information system construction device comprising:
a system model selection unit that selects a system model that satisfies a construction requirement among system models set in a unit of previously stored design information of a system when the construction requirement of a construction planned system that is an information system to be constructed is input;
an operation information acquisition unit that acquires operation information of an existing system that is an already constructed information system based on the system model selected by the system model selection unit and a similar system model that is similar to the system model selected;
a parameter computation unit that computes an evaluation parameter that is used when performance of the system model is evaluated, by using a parameter included in the operation information acquired by the operation information acquisition unit;
a performance evaluation unit that evaluates the performance of the system model selected by the system model selection unit, on the basis of the evaluation parameter computed by the parameter computation unit;
a server element change unit that changes a server element that is an element that determines a size regarding a server included in design information of the system model selected by the system model selection unit, by comparing the evaluated performance of the system model by the performance evaluation unit with the input construction requirement; and
a system construction unit that constructs the construction planned system by using the system model having the server element changed by the server element change unit.

2. The information system construction device according to claim 1, wherein
the construction requirement is a functional requirement for determining a role played by an application and a service level requirement for determining a guarantee level of quality provided by the construction planned system, and the server element change unit compares the evaluated performance of the system model by the performance evaluation unit with the input service level requirement.

3. The information system construction device according to claim 1, wherein the similar system model is the system model with another piece of the design information different from the design information of the system model selected by the system model selection unit in only the server element.

4. The information system construction device according to claim 1, wherein the performance of the system model is a non-functional requirement.

5. An information system construction method comprising:
selecting a system model that satisfies a construction requirement among system models set in a unit of previously stored design information of a system when the construction requirement of a construction planned system that is an information system to be constructed is input;
acquiring operation information of an existing system that is an already constructed information system based on the selected system model and a similar system model that is similar to the selected system model;
computing an evaluation parameter that is used when performance of the system model is evaluated, by using a parameter included in the acquired operation information;
evaluating the performance of the selected system model, on the basis of the computed evaluation parameter;
changing a server element that is an element that determines a size regarding a server included in design information of the selected system model, by comparing the evaluated performance of the system model with the input construction requirement; and
constructing the construction planned system by using the system model having the changed server element.

6. The information system construction method according to claim 5, wherein
the construction requirement is a functional requirement for determining a role played by an application and a service level requirement for determining a guarantee level of quality provided by the construction planned system, and the evaluated performance of the system model is compared with the input service level requirement in changing of the server element.

7. The information system construction method according to claim 5, wherein the similar system model is the system model with another piece of the design information different from the design information of the selected system model in only the server element.

8. The information system construction method according to claim 5, wherein the performance of the system model is a non-functional requirement.

9. A computer-readable storage medium recording an information system construction program that causes a computer to execute:
a system model selection process of selecting a system model that satisfies a construction requirement among system models set in a unit of previously stored design information of a system when the construction requirement of a construction planned system that is an information system to be constructed is input;
an operation information acquisition process of acquiring operation information of an existing system that is an already constructed information system based on the system model selected in the system model selection process and a similar system model that is similar to the system model selected;
a parameter computation process of computing an evaluation parameter that is used when performance of the system model is evaluated, by using a parameter included in the operation information acquired in the operation information acquisition process;
a performance evaluation process of evaluating the performance of the system model selected in the system model selection process, on the basis of the evaluation parameter computed in the parameter computation process;
a server element change process of changing a server element that is an element that determines a size regarding a server included in design information of the system model selected in the system model selection process, by comparing the evaluated performance of the system model in the performance evaluation process with the input construction requirement; and
a system construction process of constructing the construction planned system by using the system model having the server element changed in the server element change process.

10. The computer-readable storage medium according to claim 9, wherein
the construction requirement is a functional requirement for determining a role played by an application and a service level requirement for determining a guarantee level of quality provided by the construction planned system, and the server element change process compares the evaluated performance of the system model in the performance evaluation process with the input service level requirement.

11. The computer-readable storage medium according to claim 9, wherein the similar system model is the system model with another piece of the design information different from the design information of the system model selected in the system model selection process in only the server element.

12. The computer-readable storage medium according to claim 9, wherein the performance of the system model is a non-functional requirement.
